(19) United States
(12) Patent Application Publication
(10) Pub. No.: US 2025/0363827 A1
(43) Pub. Date: Nov. 27, 2025

(54) DEEP LEARNING-BASED METHOD AND APPARATUS FOR DETECTING GLINT IN EYE TRACKING

(71) Applicant: Nanchang Virtual Reality Research Institute Co., Ltd., Nanchang (CN)

(72) Inventors: Fenghui Mao, Nanchang (CN); Hao Xu, Nanchang (CN); Jijun Deng, Nanchang (CN); Zhenmin Guo, Nanchang (CN)

(21) Appl. No.: 19/294,342

(22) Filed: Aug. 8, 2025

Related U.S. Application Data
(63) Continuation of application No. PCT/CN2024/143932, filed on Dec. 30, 2024.

(30) Foreign Application Priority Data
Jan. 2, 2024 (CN) 202410003661.3

(51) Int. Cl. G06V 40/18; G06T 7/73; G06V 10/26; G06V 10/60; G06V 10/776; G06V 10/82

(52) U.S. Cl. CPC G06V 40/193; G06T 7/73; G06V 10/26; G06V 10/60; G06V 10/776; G06V 10/82; G06T 2207/20081; G06T 2207/20084; G06T 2207/30201

(57) ABSTRACT

This application provides a deep learning-based method and apparatus for detecting glint in eye tracking. The method includes: processing and storing data sets of a single-channel sample eyeball image with glint in a txt file; generating a first multi-channel label image corresponding to the single-channel sample eyeball image; performing, through a preliminary neural network model, semantic segmentation on the data set corresponding to the single-channel sample eyeball image to output a second multi-channel label image; determining a loss function based on the first multi-channel label image and the second multi-channel label image; iteratively optimizing the preliminary neural network model through the loss function to obtain a final neural network model; and processing a single-channel test eyeball image through the final neural network model, and performing inference to obtain a glint center and glint ordering of the single-channel test eyeball image.

### CROSS-REFERENCE TO RELATED APPLICATIONS

This application is a Continuation application of PCT Application No. PCT/CN2024/143932 filed on Dec. 30, 2024, which claims priority to Chinese Patent Application No. 2024100036613, filed with the China National Intellectual Property Administration on Jan. 2, 2024 and entitled “DEEP LEARNING-BASED METHOD AND APPARATUS FOR DETECTING GLINT IN EYE TRACKING”, which is incorporated herein by reference in its entirety.

### TECHNICAL FIELD

This application pertains to the field of deep learning technology, and in particular, relates to a deep learning-based method and apparatus for detecting glint in eye tracking.

### BACKGROUND

With the advancement of technology, gaze tracking technology has become a research hotspot. Gaze tracking is a technique used to study the movement trajectories of human eyes during visual tasks. It can record positions and durations of gaze points when a person is viewing visual information, and further make inference about the perception, cognition, and decision-making processes of human eyes in visual tasks, helping scientists understand the mechanisms of human visual information processing. Gaze tracking can be applied in many fields, such as human-computer interaction design, psychology, neuroscience, advertising, and marketing. In gaze tracking, gaze estimation is critical. However, gaze estimation requires glint detection to identify glint numbers, and the current glint detection accuracy remains insufficient. Therefore, a novel solution is needed to address this issue in the prior art.

### SUMMARY

To address or mitigate the issue in the prior art, a deep learning-based method and apparatus for detecting glint in eye tracking are proposed.

According to a first aspect, an embodiment of this application provides a deep learning-based method for detecting glint in eye tracking, including:
processing and storing data sets of a single-channel sample eyeball image with glint in a txt file;
reading a data set with a 1st digit not being 0 from the data sets of the single-channel sample eyeball image in the txt file;
generating, using an OpenCV image vision library, a floating-point image with all pixel values set to 1, where a size of the floating-point image is the same as a size of a single-channel sample eyeball image;
drawing a circle on the floating-point image, with a value, obtained by multiplying the last two values in each data set by a width and a height of the single-channel sample eyeball image, as a center, with a 1st digit of each data set as a pixel value, and with a preset pixel value as a radius, to obtain a first multi-channel label image corresponding to the single-channel sample eyeball image;
performing, through a preliminary neural network model, semantic segmentation on the data set corresponding to the single-channel sample eyeball image to output a second multi-channel label image;
determining a loss function based on the first multi-channel label image and the second multi-channel label image;
iteratively optimizing the preliminary neural network model through the loss function to obtain a final neural network model; and
processing a single-channel test eyeball image with glint through the final neural network model, and performing inference to obtain a glint center and glint ordering of the single-channel test eyeball image.

Compared with the prior art, the embodiment of this application provides a deep learning-based method for detecting glint in eye tracking, including: processing and storing data sets of a single-channel sample eyeball image with glint in a txt file; reading a data set with a 1st digit not being 0 from the data sets of the single-channel sample eyeball image in the txt file; generating, using an OpenCV image vision library, a floating-point image with all pixel values set to 1, where a size of the floating-point image is the same as a size of a single-channel sample eyeball image; drawing a circle on the floating-point image, with a value, obtained by multiplying the last two values in each data set by a width and a height of the single-channel sample eyeball image, as a center, with a 1st digit of each data set as a pixel value, and with a preset pixel value as a radius, to obtain a first multi-channel label image corresponding to the single-channel sample eyeball image; performing, through a preliminary neural network model, semantic segmentation on the data set corresponding to the single-channel sample eyeball image to output a second multi-channel label image; determining a loss function based on the first multi-channel label image and the second multi-channel label image; iteratively optimizing the preliminary neural network model through the loss function to obtain a final neural network model; and processing a single-channel test eyeball image with glint through the final neural network model, and performing inference to obtain a glint center and glint ordering of the single-channel test eyeball image. The technical solution provided in this application implements relatively accurate glint detection to identify glint numbers.

According to a second aspect, an embodiment of this application further provides a deep learning-based apparatus for detecting glint in eye tracking, including:
a processing module configured to process and store data sets of a single-channel sample eyeball image with glint in a txt file;
a generation module configured to read a data set with a 1st digit not being 0 from the data sets of the single-channel sample eyeball image in the txt file; generate, using an OpenCV image vision library, a floating-point image with all pixel values set to 1, where a size of the floating-point image is the same as a size of a single-channel sample eyeball image; and draw a circle on the floating-point image, with a value, obtained by multiplying the last two values in each data set by a width and a height of the single-channel sample eyeball image, as a center, with a 1st digit of each data set as a pixel value, and with a preset pixel value as a radius, to obtain a first multi-channel label image corresponding to the single-channel sample eyeball image;
a semantic segmentation module configured to perform, through a preliminary neural network model, semantic segmentation on the data set corresponding to the single-channel sample eyeball image to output a second multi-channel label image;
a determination module configured to determine a loss function based on the first multi-channel label image and the second multi-channel label image;
an optimization module configured to iteratively optimize the preliminary neural network model through the loss function to obtain a final neural network model; and
an inference module configured to process a single-channel test eyeball image with glint through the final neural network model, and perform inference to obtain a glint center and glint ordering of the single-channel test eyeball image.

Compared with the prior art, the beneficial effects of the deep learning-based apparatus for detecting glint in eye tracking provided in the embodiment of this application are the same as those of the technical solution provided in the first aspect, and are not repeated herein.

### BRIEF DESCRIPTION OF DRAWINGS

The drawings described herein are provided to further understand this application and constitute a part of this application. The exemplary embodiments and their descriptions are used to explain this application and do not constitute an improper limitation of this application. Some specific embodiments of this application will be described in detail below with reference to the drawings in an exemplary but non-restrictive manner. Identical reference signs in the drawings denote identical or similar components or parts. Those skilled in the art should understand that these drawings are not necessarily drawn to scale. In the drawings:

FIG. 1 is a schematic flowchart of a deep learning-based method for detecting glint in eye tracking according to an embodiment of this application;

FIG. 2 is a schematic structural diagram of a deep learning-based apparatus for detecting glint in eye tracking according to an embodiment of this application.

### DESCRIPTION OF EMBODIMENTS

To enable those skilled in the art to better understand the solutions of this application, the technical solutions in the embodiments of this application will be clearly and completely described below in conjunction with the drawings in the embodiments of this application. Apparently, the described embodiments are some but not all of the embodiments of this application. Based on the embodiments in this application, all other embodiments obtained by those of ordinary skill in the art without creative efforts shall fall within the protection scope of this application.

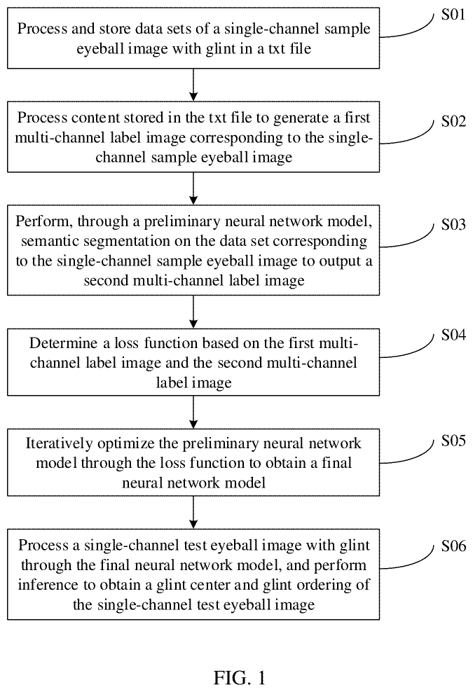

Referring to FIG. 1, according to a first aspect, an embodiment of this application provides a deep learning-based method for detecting glint in eye tracking, including the following steps.

Step S01. Process and store data sets of a single-channel sample eyeball image with glint in a txt file.

Step S01 specifically includes: acquiring the single-channel sample eyeball image with glint;

on the acquired single-channel sample eyeball image, sequentially labelling a glint center of each single-channel sample eyeball image and normalizing the glint center of each single-channel sample eyeball image; and storing the single-channel sample eyeball image with the normalized glint center in a txt file.

It should be noted that a single-channel sample eyeball image with glint is acquired using a related device (the device may be a VR headset, with a ring of lights and a camera installed at positions corresponding to the left and right eye corners, where images of the left and right eyeballs are acquired through the cameras). On the acquired single-channel sample eyeball image, glint center positions are manually labeled in sequence, and the glint center positions are normalized. A position where no glint is captured has both the label and coordinates set to 0. The single-channel sample eyeball image with the normalized glint center is stored in a txt file.

The data stored in the txt file is similar to the following:
1 0.834609 0.384967 (number 1); 1 0.864758 0.784047 (number 2); 1 0.794779 0.567892 (number 3); 0 0.000000 0.000000 (number 4); 1 0.694934 0.749345 (number 5); 0 0.000000 0.000000 (number 6); 0 0.000000 0.000000 (number 7); 1 0.479966 0.397679 (number 8).

Starting from the eye corner, the left eye is labeled in a clockwise order, and the right eye is labeled in a counterclockwise order. In the above data, the first integer 1 indicates the presence of a glint, and the integer 0 indicates the absence of a glint. The following two decimals represent a position of the glint center relative to the image center. For example, for the first three values: 1 0.834609 0.384967, 1 indicates presence of a glint at the eye corner position. Assuming that pixel coordinates of the glint center position are (x, y) and the width and height of the image are H and W, x/W=0.834609, y/H=0.384967; 0 0.000000 0.000000 indicates no glint detected. The above data indicates a total of 8 glint points, with glints detected at 5 glint points.

Step S02. Process content stored in the txt file to generate a first multi-channel label image corresponding to the single-channel sample eyeball image.

Step S02 specifically includes: reading a data set with a 1st digit not being 0 from the data sets of the single-channel sample eyeball image in the txt file;
generating, using an OpenCV image vision library, a floating-point image with all pixel values set to 1, where a size of the floating-point image is the same as a size of the single-channel sample eyeball image; and
drawing a circle on the floating-point image, with a value, obtained by multiplying the last two values in each data set by a width and a height of the single-channel sample eyeball image, as a center, with a 1st digit of each data set as a pixel value, and with a preset pixel value as a radius, to obtain a first multi-channel label image corresponding to the single-channel sample eyeball image.

It should be noted that the data sets whose 1st digit in the label is not 0 are read from the txt file: (number 1) 1 0.834609 0.384967; (number 2) 1 0.864758 0.784047; (number 3) 1 0.794779 0.567892; (number 5) 1 0.694934 0.749345; (number 8) 1 0.479966 0.397679; (with three values in each set), and the label data is modified to the corresponding number plus 1, so the data sets in the above txt file become:

$$[ [ 2 0.834609 0.384967 ] [ 3 0.864758 0.784047 ] [ 4 0.794779 0.567892 ] [ \text{} 6 0.694934 0.749345 ] [ 9 0.479966 0.397679 ] ]$$

A floating-point image with all pixel values set to 1 is generated through the OpenCV image vision library. An image size of the floating-point image is consistent with a size of an original image acquired by the camera. A width and a height of the floating-point image are H and W, respectively. Then, a filled circle (that is, a solid circle) is drawn on the floating-point image, with a value, obtained by multiplying the last two values of each data set by the image width and height, as a center, with the 1st digit as a pixel value, and with a radius of R (R=4 pixels). The solid circles represent glint points in a region with identical pixels.

For example, for the data set [2 0.834609 0.384967]: a solid circle with a radius of 4 pixels is drawn, with x_{center}=0.834609*W and y_{center}=0.384967*H as the center coordinates, and with the first digit 2 as the pixel value.

In this way, each single-channel sample eyeball image generates a first multi-channel label image with the same name as the original image.

Step S03. Perform, through a preliminary neural network model, semantic segmentation on the data set corresponding to the single-channel sample eyeball image to output a second multi-channel label image;

It should be noted that the preliminary neural network model is designed with an input of batch*m*W*H and an output of batch*n*W*H, where batch is the number of label images corresponding to the single-channel sample eyeball image used in each iteration, m and n represent the number of channels, and W and H represent the width and height of the label image corresponding to the single-channel sample eyeball image.

It should be noted that after the semantic segmentation through the neural network, a single-channel image is converted into a multi-channel label image. In the embodiment of this application, if a single-channel image has 9 pixels, the single-channel image is a grayscale image, with a pixel value of each pixel being one of 1 to 9. Then converting the single-channel image into a multi-channel image label essentially transforms it into 9 single-channel binary images. In each binary image, the pixel value is 0 or 1. For example, in the 1st image, except for the pixels with a pixel value of 1, the pixel values of other regions are all 0. For another example, in the 2nd image, only the corresponding pixels with a pixel value of 2 in the single-channel image are set to 1, while the pixels in other regions are all set to 0. By analogy, a 9-channel image label is obtained.

In specific applications, in the 1st channel, all pixel values within the drawn circular region is 0, while pixel values outside the drawn circular region are 1. In the 2nd channel, if the pixels within the drawn circle have a pixel value of 1, pixels outside the drawn circular region have a pixel value of 0. In the 3rd channel, if the pixels within the drawn circle have a pixel value of 1, pixels outside the drawn circular region have a pixel value of 0. By analog, the second multi-channel label image 1 is obtained.

In the embodiment of this application, the preliminary neural network model is a Net network model, where the Net network model may be a Le-Net network model.

In the embodiment of this application, the first multi-channel label image and the second multi-channel label image are both multiple binary images, with each pixel value being 0 or 1.

Step S04. Determine a loss function based on the first multi-channel label image and the second multi-channel label image.

Step S04 specifically includes: obtaining a loss value loss₁ between a 1st channel label image of the first multi-channel label image and a 1st channel label image of the second multi-channel label image, and a loss value loss₂ between other channel label images of the first multi-channel label image and other channel label images of the second multi-channel label image; and determining the loss function according to the following formula:

$$loss = {w}_{1} * {loss}_{1} + {w}_{2} * {loss}_{2}$$

where w₁ and w₂ represent weight values of the loss value loss₁ and the loss value loss₂, respectively.

It should be noted that the loss function consists of two parts: one part is the loss value loss₁ between the 1st first multi-channel label image of the single-channel sample eyeball image and the 1st second multi-channel channel label image output by the preliminary neural network, and the other part is the loss value loss₂ between other channel label images of the single-channel sample eyeball image and other channel label images output by the preliminary neural network.

Step S05. Iteratively optimize the preliminary neural network model through the loss function to obtain a final neural network model.

It should be noted that the preliminary neural network model is continuously optimized using the above loss values until the preliminary neural network model fully converges, outputting the final neural network model.

Step S06. Process a single-channel test eyeball image with glint through the final neural network model, and perform inference to obtain a glint center and glint ordering of the single-channel test eyeball image.

Step S06 specifically includes: inputting the acquired single-channel test eyeball image into the final neural network model to obtain a third multi-channel label image of the single-channel test eyeball image;
sequentially polling the third multi-channel label image of the single-channel test eyeball image to determine a single-channel image, where a pixel value at each pixel coordinate point of the single-channel image is a channel number of a maximum pixel value at a same pixel coordinate point as the third multi-channel label image;
obtaining a binary image with a same resolution as a pixel value at each pixel coordinate point of the single-channel image; and
determining, through a findContours function in the OpenCV image vision library, a center position of each connected domain in each channel of the binary image, where the connected domain corresponds to a glint number, and obtaining the glint center position and the glint ordering based on the glint number.

It should be noted that a single-channel test eyeball image is acquired and input into the final neural network model for inference, so as to output a third multi-channel label image output 1.

Each channel of the third multi-channel label image output1 is polled to obtain a channel with a maximum pixel value, so as to determine a single-channel image output2, where a pixel value at each pixel coordinate point in the single-channel image output2 is a channel number corresponding to a maximum pixel value at a same pixel coordinate point as the third multi-channel label image.

If there are 9 glint points, the first channel is channel 0, and the channels of the third multi-channel label image output1 are sequentially 0, 1, 2, 3, 4, 5, 6, 7, 8, that is, 9 channels. For example, if the pixel values at pixel coordinate (0,0) in output1 across all channels are [0.034554 0.05459 0.000000 0.000000 0.007462 0.934712 0.000000 0.0034401 0.000000], the maximum pixel value is 0.934712, corresponding to channel number 5. Then, the pixel value at pixel coordinate (0,0) in the single-channel image output2 is 5. This process is repeated for all pixels in output1 to obtain the pixel value at each pixel coordinate point in the single-channel image output2.

Based on the pixel value at each pixel coordinate point in the single-channel image output2, a binary image output3 with a same resolution as the single-channel image output2 is obtained, where the pixel value of the binary image output3 is 255.

Through the findContours function in the OpenCV image vision library, the center position of each connected domain in the binary image output3 is determined, thereby inferring the glint center through the final neural network model.

The connected domains in the binary image output3 correspond to the pixel values in the single-channel image output2, which are the glint numbers. In this way, both the glint center position and the glint ordering are obtained, providing effective data for subsequent gaze tracking.

In the embodiment of this application, glint points are processed as glint point regions, that is, a point-to-surface sample label generation method is used, transforming the glint detection problem into a semantic segmentation problem, thereby effectively and quickly implementing glint detection. With the semantic segmentation concept applied to glint detection in gaze tracking, natural light and tear points can be removed, effectively overcoming interference from natural light and tear points in the eyes. Post-processing of the results inferred by deep learning effectively extracts glint points and ensures the accuracy of glint ordering, providing strong support for subsequent gaze tracking and eye movement posture estimation.

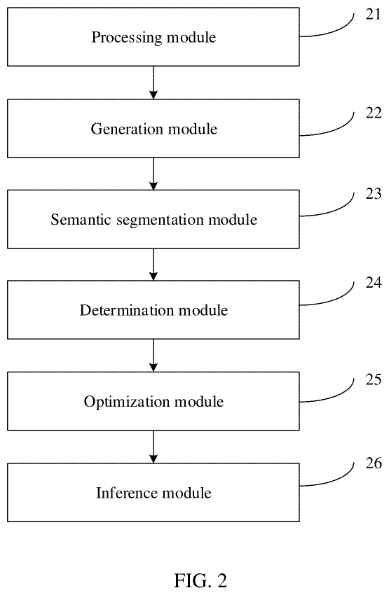

Referring to FIG. 2, according to a second aspect, an embodiment of this application further provides a deep learning-based apparatus for detecting glint in eye tracking, including:
a processing module 21 configured to process and store data sets of a single-channel sample eyeball image with glint in a txt file;
a generation module 22 configured to read a data set with a 1st digit not being 0 from the data sets of the single-channel sample eyeball image in the txt file; generate, using an OpenCV image vision library, a floating-point image with all pixel values set to 1, where a size of the floating-point image is the same as a size of the single-channel sample eyeball image; and draw a circle on the floating-point image, with a value, obtained by multiplying the last two values in each data set by a width and a height of the single-channel sample eyeball image, as a center, with a 1st digit of each data set as a pixel value, and with a preset pixel value as a radius, to obtain a first multi-channel label image corresponding to the single-channel sample eyeball image;
a semantic segmentation module 23 configured to perform, through a preliminary neural network model, semantic segmentation on the data set corresponding to the single-channel sample eyeball image to output a second multi-channel label image;
a determination module 24 configured to determine a loss function based on the first multi-channel label image and the second multi-channel label image;
an optimization module 25 configured to iteratively optimize the preliminary neural network model through the loss function to obtain a final neural network model; and
an inference module 26 configured to process a single-channel test eyeball image with glint through the final neural network model, and perform inference to obtain a glint center and glint ordering of the single-channel test eyeball image.

Compared with the prior art, the beneficial effects of the deep learning-based apparatus for detecting glint in eye tracking provided in the embodiment of this application are the same as those of the technical solution provided in the first aspect, and are not repeated herein.

Finally, it should be noted that the above embodiments are only used to illustrate the technical solutions of this application, not to limit them. Although this application has been described in detail with reference to the foregoing embodiments, those of ordinary skill in the art should understand that they can still modify the technical solutions described in the foregoing embodiments or make equivalent replacements for some or all of the technical features. Such modifications or replacements do not cause the essence of the corresponding technical solutions to depart from the scope of the technical solutions of the embodiments of this application.

1. A deep learning-based method for detecting glint in eye tracking, comprising:
processing and storing data sets of a single-channel sample eyeball image with glint in a txt file;
reading a data set with a 1st digit not being 0 from the data sets of the single-channel sample eyeball image in the txt file;
generating, using an OpenCV image vision library, a floating-point image with all pixel values set to 1, wherein a size of the floating-point image is the same as a size of a single-channel sample eyeball image;
drawing a circle on the floating-point image, with a value, obtained by multiplying the last two values in each data set by a width and a height of the single-channel sample eyeball image, as a center, with a 1st digit of each data set as a pixel value, and with a preset pixel value as a radius, to obtain a first multi-channel label image corresponding to the single-channel sample eyeball image;
performing, through a preliminary neural network model, semantic segmentation on the data set corresponding to the single-channel sample eyeball image to output a second multi-channel label image;
determining a loss function based on the first multi-channel label image and the second multi-channel label image;
iteratively optimizing the preliminary neural network model through the loss function to obtain a final neural network model; and
processing a single-channel test eyeball image with glint through the final neural network model to infer a glint center and glint ordering of the single-channel test eyeball image.

2. The deep learning-based method for detecting glint in eye tracking according to claim 1, wherein the processing and storing data sets of a single-channel sample eyeball image with glint in a txt file comprises:
acquiring the single-channel sample eyeball images with glint;
on the acquired single-channel sample eyeball images, sequentially labelling a glint center of each single-channel sample eyeball image and normalizing the glint center of each single-channel sample eyeball image; and
storing a data set of the single-channel sample eyeball images with the normalized glint centers in a txt file.

3. The deep learning-based method for detecting glint in eye tracking according to claim 1, wherein the determining a loss function based on the first multi-channel label image and the second multi-channel label image comprises:
obtaining a loss value loss₁ between a 1st channel label image of the first multi-channel label image and a 1st channel label image of the second multi-channel label image, and a loss value loss₂ between other channel label images of the first multi-channel label image and other channel label images of the second multi-channel label image; and determining the loss function according to the following formula:
$$loss = {w}_{1} * {loss}_{1} + {w}_{2} * {loss}_{2}$$
wherein w₁ and w₂ represent weight values of the loss value loss and the loss value loss₂, respectively.

4. The deep learning-based method for detecting glint in eye tracking according to claim 3, wherein the first multi-channel label image and the second multi-channel label image are both multiple binary images, with each pixel value being 0 or 1.

5. The deep learning-based method for detecting glint in eye tracking according to claim 4, wherein the processing the single-channel test eyeball image with glint through the final neural network model, and performing inference to obtain a glint center and glint ordering of the single-channel test eyeball image comprises:
inputting the acquired single-channel test eyeball image into the final neural network model to obtain a third multi-channel label image of the single-channel test eyeball image;
sequentially polling the third multi-channel label image of the single-channel test eyeball image to determine a single-channel image, wherein a pixel value at each pixel coordinate point of the single-channel image is a channel number corresponding to a maximum pixel value at a same pixel coordinate point as the third multi-channel label image;
obtaining a binary image with a same resolution as the pixel values at each pixel coordinate point of the single-channel image; and
determining, using a findContours function in the OpenCV image vision library, a center position of each connected domain in each channel of the binary image, wherein the connected domain corresponds to a glint number, and obtaining the glint center position and the glint ordering based on the glint number.

6. A deep learning-based apparatus for detecting glint in eye tracking, comprising:
a processing module configured to process and store data sets of a single-channel sample eyeball image with glint in a txt file;
a generation module configured to read a data set with a 1st digit not being 0 from the data sets of the single-channel sample eyeball image in the txt file; generate, using an OpenCV image vision library, a floating-point image with all pixel values set to 1, wherein a size of the floating-point image is the same as a size of a single-channel sample eyeball image; and draw a circle on the floating-point image, with a value, obtained by multiplying the last two values in each data set by a width and a height of the single-channel sample eyeball image, as a center, with a 1st digit of each data set as a pixel value, and with a preset pixel value as a radius, to obtain a first multi-channel label image corresponding to the single-channel sample eyeball image;
a semantic segmentation module configured to perform, through a preliminary neural network model, semantic segmentation on the data set corresponding to the single-channel sample eyeball image to output a second multi-channel label image;
a determination module configured to determine a loss function based on the first multi-channel label image and the second multi-channel label image;
an optimization module configured to iteratively optimize the preliminary neural network model through the loss function to obtain a final neural network model; and
an inference module configured to process a single-channel test eyeball image with glint through the final neural network model, and perform inference to obtain a glint center and glint ordering of the single-channel test eyeball image.
